(19) United States
(12) Patent Application Publication
(10) Pub. No.: US 2019/0178590 A1
(43) Pub. Date: Jun. 13, 2019

(54) FRAC RADIATOR FILTER ASSEMBLY

(71) Applicant: GLOBAL HEAT TRANSFER ULC, Edmonton (CA)

(72) Inventors: Randy Vanberg, Tomball, TX (US); Seyed Reza Larimi, Edmonton (CA); Hamid Reza Zareie Rajani, Edmonton (CA); Hamad Abdi Hassan, Edmonton (CA); Brian Barney, Peoria, IL (US)

(21) Appl. No.: 16/026,092

(22) Filed: Jul. 3, 2018

Related U.S. Application Data
(60) Provisional application No. 62/596,716, filed on Dec. 8, 2017.

(51) Int. Cl. F28F 19/01; E21B 43/26; B01D 39/08; B01D 46/02; B01D 46/00

(52) U.S. Cl. CPC F28F 19/01; E21B 43/26; B01D 39/083; B01D 46/02; B01D 2239/1233; B01D 2265/02; B01D 2279/00; B01D 2239/1216; B01D 46/0005

(57) ABSTRACT

A filter assembly for a heat exchanger unit having a pliable body made of a filter medium. The filter assembly has a first end extending from an inner region through a middle portion to an outer perimeter end, and a second end extending from the inner region through the middle portion to the outer perimeter end. The second end is configured for coupling with the first end. The assembly has a central opening, and a mount insert coupled with the pliable body in the central opening.

### INCORPORATION BY REFERENCE

The subject matter of co-pending U.S. non-provisional application Ser. Nos. 15/705,024, filed Sep. 14, 2017, 15/629,563, filed Jun. 21, 2017, 15/591,076, filed May 9, 2017, and 15/477,097 and 15/477,100, each filed Apr. 2, 2017, is incorporated herein by reference in entirety for all purposes. One or more of these applications may be referred to herein as the “Applications”.

### STATEMENT REGARDING FEDERALLY SPONSORED RESEARCH OR DEVELOPMENT

Not Applicable.

### BACKGROUND

### Field of the Disclosure

This disclosure generally relates to a heat exchanger unit with characteristics of improved: airflow, cleaning, noise reduction, cooling efficiency, and/or structural integrity. In some embodiments, the disclosure relates to a heat exchanger unit used in connection with equipment found in an industrial setting. The heat exchanger unit may be used for cooling various utility fluids used with a heat generating device, such as an engine, a pump, or a genset. Other embodiments pertain a filtration system or apparatus suitable to clean airflow prior to intake into the heat exchanger unit.

### Background of the Disclosure

Whether it is refrigeration, hot showers, air conditioning, and so on, the function of heating and cooling is prevalent in today's residential and industrial settings. One area of relevance is the oil and gas industry, including exploration, upstream, and downstream operations where the ability to heat and/or cool is critical. Upstream operations can include drilling, completion, and production, whereas downstream operations can include refining and other related hydrocarbon processing, all of which utilize a vast amount of process equipment including that which provide heat transfer. To be sure, the background of the disclosure is relevant elsewhere, but for brevity discussion is focused on O&G.

A particular segment in the upstream area of oil and gas production pertains to fracing. Now prevalent, fracing includes the use of a plug set in a wellbore below or beyond a respective target zone, followed by pumping or injecting high pressure frac fluid into the zone. The frac operation results in fractures or “cracks” in the formation that allow valuable hydrocarbons to be more readily extracted and produced by an operator, and may be repeated as desired or necessary until all target zones are fractured.

The injection fluid, which may be mixed with chemicals, sand, acid, etc., may be pressurized and transported at high rate via one or more high pressure frac pumps, typically driven by diesel combustion engines. Common settings in this context are nothing short of challenging in the sense that in many instances operations and processes (and related equipment) are exposed to environmental conditions, such as extreme heat, cold, wind, and dust (including natural amounts of particulate, as well as that caused by the operation of equipment and vehicles).

It is routine to have (indeed, need) some type of heat exchange ability in such settings. As set forth in U.S. Ser. No. 15/477,097, an example operation in an industrial setting may include one or more frac pump units. Each unit is typically operable with a pump and engine mounted or otherwise disposed thereon, as well as a radiator (or analogously referred to as cooler, heat exchanger, etc.). As mentioned before, equipment like this must be rugged and durable in order to have long-term operational capacity and effectiveness.

The radiator is configured for cooling one or more hot service fluids associated with the operating equipment of the frac pump unit, such as lube oil or jacket water. The radiator typically includes a ‘core’ of stacked fins, with one part of the core providing a flow are for the service fluid(s), while another part of the core provides a proximate, albeit separate, flow area for ambient air. A fan is used to blow or pull air through the stacked fins, the air being a low or moderate enough temperature to cool the service fluid, which is then recirculated in a loop.

The stacked fins often have a configuration that is tantamount to an extensive amount of small air passageways proximate to (albeit separate from) service fluid passageways, whereby the air and the service fluid can ‘exchange heat’ via the surface material of the stacked fins between the passageways (e.g., aluminum).

Over time airborne dirt, sand, water, oil, grease, and other particulate in the air will begin to deposit on the air intake side (and elsewhere), resulting in a fouled radiator. Fouling can seriously deteriorate the capacity of the surface of the fins to transfer heat under the conditions for which they were designed. Among other problems, the fouling layer has a low thermal conductivity which increases the resistance to heat transfer and reduces the effectiveness of heat exchangers. In addition, fouling reduces the cross-sectional area in the passageways, which causes an increase in pressure drop across a heat exchanger.

Radiator fouling affects both capital and operating costs of heat exchangers (and overall processes). Higher capital expenditures include that for excess surface area (for heat transfer), extra space, and transport and installation costs. Operating expenditures include that for energy losses due to the decrease in thermal efficiency, increases in the pressure drop through process equipment, and production losses during planned and unplanned plant shutdowns for fouling cleaning.

In summary, fouling of heat transfer surfaces is one of the most important problems in heat transfer equipment. Some have described fouling as the major unresolved problem in heat transfer. Equipment operators world-wide are also trying to reduce maintenance costs. One of the highest maintenance costs any piece of equipment has is cooling system maintenance.

And yet despite these detriments, consideration of improved remediation or management techniques have been largely ignored and unchanged. Mechanical cleaning is used, but only during predetermined periodic intervals, such as during a planned shutdown or when an exchanger reaches a point of failure and is no longer operable. This approach relies on extensive cost and resource being allocated toward the antiquated philosophy of operational redundancy.

Today's typical frac radiators may have a vertical, horizontal, or even cubed orientation. Depending on configuration, a fan either blows or sucks air through each of these systems. In either instance, any debris (dust, oil, particulate, etc.) in the air must pass through a respective radiator core before exhausting. Over time the radiator becomes clogged (fouls), and loses its ability to cool the heat generating device. The HGD then overheats and must shutdown in order to protect itself from catastrophic damage. The operator must then clean the radiator either on site or in the field.

Cleaning a radiator in the field is extremely difficult as the only way to clean it is either from blasting dry ice or water from the top or bottom of the radiator. No matter which way the operator tries to clean, such a process may take 2 to 3 days, or longer, depending on the operator's experience in removing and installing radiators. In other instances, the radiator needs to be serviced or cleaned offsite in a controlled service yard where hazardous water runoff can be collected.

Environmental regulations place restrictions on water run off during cleaning of equipment to prevent oil, grease and contaminants from entering the ground water. For this reason, most heavy-duty equipment is not serviced and cleaned in the field and is instead performed in a service yard where water run-off is collected, filtered and treated.

There is a need in the art for cost-effective prevention (or mitigation) of fouling, particularly in a manner that does not require shutting down equipment. The market requires a solution to this problem. There is a need in the art to overcome deficiencies and defects identified herein.

### SUMMARY

Embodiments herein pertain to frac radiator filtration, including assembly, apparatus, system, and methodology, which a filter is installed prior or proximate to the fan. The filter may prevent or mitigate dust and debris from entering the radiator. When the filter clogs, a user may either clean or replace the filter depending on preference. The filter may be easily installed and removed from the radiator offering the user a quick and easy solution.

Embodiments herein pertain to a monitored heat exchanger system that may include a heat exchanger unit in operable engagement with a heat generating device, with an at least one service fluid being transferable therebetween, the heat exchanger unit further having a frame. There may be at least one cooler coupled with the frame, the at least one cooler having an airflow side and a service fluid side.

Other embodiments herein pertain to a filter assembly that may include a pliable body made of a filter medium. The assembly may have a first end extending from an inner region through a middle portion to an outer perimeter end. The assembly may have a second end extending from the inner region through the middle portion to the outer perimeter end. The first end and the second end may be configured for coupling together.

The assembly may include an outer perimeter comprising the outer perimeter end. There may be a drawstring disposed circumferentially around the outer perimeter end. The assembly may include a central opening. There may be a mount insert coupled with the pliable body in the central opening. The mount insert may include a closeable opening. In aspects, the mount insert may be positionable around a fan motor housing and the closeable opening being closeable therearound.

The filter medium may include or be made of a nylon or a nylon-based material. The filter medium may have a percent opening. The percent opening may be defined by an average mesh size opening, and an average thread size. In aspects, the average mesh size opening may be in the range of 300 microns to 625 microns. In aspects, the average thread size may be in the range of 50 microns to 180 microns. In other aspects, the average mesh size opening may be in the range of 590 microns to 610 microns.

The drawstring may be configured for tightening the outer perimeter end around a fan guard associated with a fan. The fan may be operable to blow air into a heat exchanger unit. The fan (and thus the fan motor/shaft) may operate with a fan speed in the range of 600 rpm to 2000 rpm. In aspects, the fan speed may be about 900 rpm to about 1100 rpm.

The assembly may include an inner drawstring disposed around an inner region perimeter end. The inner drawstring may be configured for tightening the mount insert around an object, such as the fan motor housing. The first end and the second end may be configured to provide a hook and loop coupling along the entirety of each. The mount insert may be cylindrically shaped with openings on either end thereof.

Yet other embodiments herein pertain to a heat exchanger system that may include a heat exchanger unit with a filter assembly coupled therewith. The heat exchanger unit may include one or more of: a frame; an at least one cooler coupled with the frame; and an at least one fan system coupled with the frame proximate to the at least one cooler.

The fan system may include a motor operationally coupled with a rotating member, such as via a shaft. There may be a fan motor housing disposed at least partially around the motor. There may be a fan or finger guard coupled to the frame and/or around the rotating member.

The filter assembly may include a pliable body made of a filter medium. The body of the filter assembly include a first end extending from an inner region through a middle portion to an outer perimeter end. There may be a second end extending from the inner region through the middle portion to the outer perimeter end. The first end and the second end may be configured for coupling to each other.

The body may include an outer perimeter comprising the outer perimeter end. There may be a drawstring disposed circumferentially around the outer perimeter end, such as via a hem or other conduit. The body may have a central opening.

There filter assembly may include a mount insert coupled with the pliable body in the central opening. The mount insert may include a closeable opening. The mount insert may be positionable around an objection, such as the fan motor housing. In aspects, the closeable opening may be closeable therearound.

The filter medium may include or be made from a nylon or a nylon-based material. The filter medium may include a percent opening. The percent opening may be defined by one or more of an average mesh size opening, and an average thread size.

The average mesh size opening may be in the range of about 300 microns to about 625 microns. The average thread size may be in the range of about 50 microns to about 180 microns. In aspects, the average mesh size opening may be in the range of 590 microns to 610 microns.

The rotating member may be operable in a manner to move, or otherwise blow, air through the at least one cooler. The drawstring may be configured for tightening the outer perimeter end around either of the frame or a fan guard associated with the fan.

There may be an inner drawstring disposed circumferentially around an inner region perimeter end. The inner drawstring may be configured for tightening the mount insert around the fan motor housing. The fan may operate at a fan speed in the range of 900 rpm to 1000 rpm.

The first end and the second end may be configured to provide or otherwise have a hook and loop coupling along the entirety of each. The mount insert may be cylindrically shaped. There may be openings on either end thereof.

The heat exchanger unit may be operably coupled with a heat generating device. In aspects, the heat generating device may be a diesel engine operably associated with a frac pump. The heat exchanger unit, the diesel engine, and the frac pump may be disposed on a frac trailer.

Still other embodiments of the disclosure pertain to a heat exchanger system that may include: a heat generating device; a heat exchanger unit operably coupled with the heat generating device, and a filter assembly coupled with the heat exchanger unit.

The heat exchanger unit may include one or more of: a frame; an at least one cooler coupled with the frame; and an at least one fan system coupled with the frame proximate to the at least one cooler.

The fan system may include: a motor operationally coupled with a rotating member, and a fan motor housing disposed at least partially around the motor. There may be a fan guard coupled to the frame and around the rotating member.

The filter assembly may include a pliable body made of a filter medium. The body of the assembly may have a first end extending from an inner region through a middle portion to an outer perimeter end. The body may have a second end extending from the inner region through the middle portion to the outer perimeter end. The second end may be configured for coupling with the first end, and/or vice versa. The body may include an outer perimeter comprising the outer perimeter end. There may be a drawstring disposed around the outer perimeter end

The body of the assembly may have a central opening. There may be a mount insert coupled with the pliable body in the central opening. The mount insert may include a closeable opening. The mount insert may be positionable around the fan motor housing and the closeable opening being closeable therearound.

The filter medium may include or be made of a nylon or a nylon-based material. The filter medium may include a percent opening defined by an average mesh size opening, and an average thread size. The average mesh size opening may be in the range of 300 microns to 625 microns. The average thread size may be in the range of 50 microns to 180microns. The rotating member may be operable to move or otherwise blow air through the at least one cooler. The drawstring may be configured for tightening the outer perimeter end around a fan guard associated with a fan blowing air into a heat exchanger unit.

There may be an inner drawstring disposed around an inner region perimeter end. The inner drawstring may be configured for tightening the mount insert around the fan motor housing.

The first end and the second end may be configured to provide or otherwise have a hook and loop coupling along the entirety of each. The mount insert may be cylindrically shaped with openings on either end thereof.

In aspects, the heat generating device may be a diesel engine operably associated with a frac pump. The heat exchanger unit, the diesel engine, and the frac pump may be disposed on a frac trailer. The frac pump may be operable to inject fluid into a wellbore. The fan may operate with a fan speed in a range of 600 rpm to 2000 rpm.

There may be a service fluid transferred from the heat generating device to the heat exchanger unit for cooling. The service fluid may be one of lube oil, hydraulic fluid, fuel, and transmission fluid.

The fan guard may have a clearance between respective windings in a range of ⅛″ to about ½″. The fan guard may have a depth in a range of 1″ to 7″. The filter assembly may be generally circular. The filter assembly may have a body diameter in a range of about 70″ to about 90″.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1A shows a side view of a heat exchanger unit having an at least one filter assembly, and coupled with a heat generation device according to embodiments of the disclosure;

FIG. 1B shows a close-up side view of the at least one filter assembly of FIG. 1A coupled to the heat exchanger unit according to embodiments of the disclosure;

FIG. 2A shows a side view of a heat exchanger unit configured with a blower, and having an at least one filter assembly, according to embodiments of the disclosure;

FIG. 2B shows a close-up view of a fan finger guard according to embodiments of the disclosure;

FIG. 2C shows a frac pump system according to embodiments of the disclosure;

FIG. 2D shows a side view of a filer assembly coupled around a fan guard according to embodiments of the disclosure;

FIG. 3A shows an isometric view of a filter assembly having a first end and a second end according to embodiments of the disclosure;

FIG. 3B shows a close-up view of the assembly of FIG. 3A coupled together according to embodiments of the disclosure;

FIG. 3C shows a close-up view of an insert mount of the assembly of FIG. 3A according to embodiments of the disclosure;

FIG. 3D shows an isometric view of ends of the assembly of FIG. 3A uncoupled according to embodiments of the disclosure;

FIG. 3E shows a close-up view of a filter material according to embodiments of the disclosure;

FIG. 4A shows a side view of a filter assembly coupled with a heat exchanger unit according to embodiments of the disclosure;

FIG. 4B shows an isometric view of a filter assembly suitable for use with a heat exchanger unit according to embodiments of the disclosure;

FIG. 4C shows a partial side view of a filter assembly and a mount suitable for use with a heat exchanger unit according to embodiments of the disclosure;

FIG. 4D shows an isometric view of a rollable filter assembly suitable for use with a heat exchanger unit according to embodiments of the disclosure;

FIG. 4E shows a side view of a rollable filter assembly suitable for use with a heat exchanger unit according to embodiments of the disclosure;

FIG. 5A shows a front view of a modified finger guard according to embodiments of the disclosure; and

FIG. 5B shows an isometric view of a rigid filter assembly according to embodiments of the disclosure.

### DETAILED DESCRIPTION

Herein disclosed are novel assemblies, apparatuses, systems, and methods that pertain to heat exchanger technology and aspects (including components) related thereto, details of which are described herein.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” “right”, “left”, “down”, etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure.

Embodiments herein may be described at the macro level, especially from an ornamental or visual appearance. Thus, a dimension, such as length, may be described as having a certain numerical unit, albeit with or without attribution of a particular significant figure. One of skill in the art would appreciate that the dimension of “2 centimeters” may not be exactly 2 centimeters, and that at the micro-level may deviate. Similarly, reference to a “uniform” dimension, such as thickness, need not refer to completely, exactly uniform. Thus, a uniform or equal thickness of “1 millimeter” may have discernable variation at the micro-level within a certain tolerance (e.g., 0.001 millimeter) related to imprecision in measuring and fabrication.

Terms

The term “engine” as used herein can refer to a machine with moving parts that converts power into motion, such as rotary motion. The engine can be powered by a source, such as internal combustion.

The term “motor” as used herein can be analogous to engine. The motor can be powered by a source, such as electricity, pneumatic, or hydraulic.

The term “drive” (or drive shaft) as used herein can refer to a mechanism that controls or imparts rotation of a motor(s) or engine(s).

The term “pump” as used herein can refer to a mechanical device suitable to use an action such as suction or pressure to raise or move liquids, compress gases, and so forth. ‘Pump’ can further refer to or include all necessary subcomponents operable together, such as impeller (or vanes, etc.), housing, drive shaft, bearings, etc. Although not always the case, ‘pump’ can further include reference to a driver, such as an engine and drive shaft. Types of pumps include gas powered, hydraulic, pneumatic, and electrical.

The term “frac pump” as used herein can refer to a pump that is usable with a frac operation, including being able to provide high pressure injection of a slurry into a wellbore. The frac pump can be operable in connection with a motor or engine. In some instances, and for brevity, ‘frac pump’ can refer to the combination of a pump and a driver together.

The term “frac truck” as used herein can refer to a truck (or truck and trailer) useable to transport various equipment related to a frac operation, such as a frac pump and engine, and a radiator.

The term “frac operation” as used herein can refer to fractionation of a downhole well that has already been drilled. ‘Frac operation’ can also be referred to and interchangeable with the terms fractionation, hydrofracturing, hydrofracking, fracking, fracing, and frac. A frac operation can be land or water based.

The term “radiator” as used herein can refer to or interchangeable with the term ‘heat exchanger’ or ‘heat exchanger panel’. The radiator can be a heat exchanger used to transfer thermal energy from one medium to another for the purpose of cooling and/or heating.

The term “cooler” as used herein can refer to a radiator made up of tubes or other structure surrounded by fins (or ‘core’) that can be configured to extract heat from a fluid moved through the cooler. The term can be interchangeable with ‘heat exchanger panel’ or comparable. Heat can also be exchanged to another fluid, such as air.

The term “cooling circuit” as used herein can refer to a cooler and respective components.

The term “core” as used herein can refer to part of a cooler, and can include multiple layers of fins, fin elements, a lattice structure, or a plurality of interconnected cell modules.

The term “heat exchanger unit” as used herein can refer to a device or configuration that uses one or more coolers along with other components, such as a fan, mounts, tubing, frame, and so on. The heat exchanger unit can be independent and standalone or can be directly mounted to a heat generating device. The heat exchanger unit can be operable to pull (draw) ambient air in through the coolers in order to cool one or more service fluids. The heated air is moved or blown out as a waste exhaust stream. Heat exchanger unit can be interchangeable to the term ‘radiator’ and like.

The term “heat generating device” (or sometimes ‘HGD’) as used herein can refer to an operable device, machine, etc. that emits or otherwise generates heat during its operation, such as an engine, motor, a genset, or a frac pump (including the pump and/or respective engine). The HGD can be for an industrial or a residential setting.

The term “genset” (or generator set) as used herein can refer to a ‘diesel generator’ or the combination of a diesel engine (or comparable) and an electric generator. The genset can convert mechanical energy to electrical energy.

The term “utility fluid” as used herein can refer to a fluid used in connection with the operation of a heat generating device, such as a lubricant or water. The utility fluid can be for heating, cooling, lubricating, or other type of utility. ‘Utility fluid’ can also be referred to and interchangeable with ‘service fluid’ or comparable.

The term “mounted” as used herein can refer to a connection between a respective component (or subcomponent) and another component (or another subcomponent), which can be fixed, movable, direct, indirect, and analogous to engaged, coupled, disposed, etc., and can be by screw, nut/bolt, weld, and so forth.

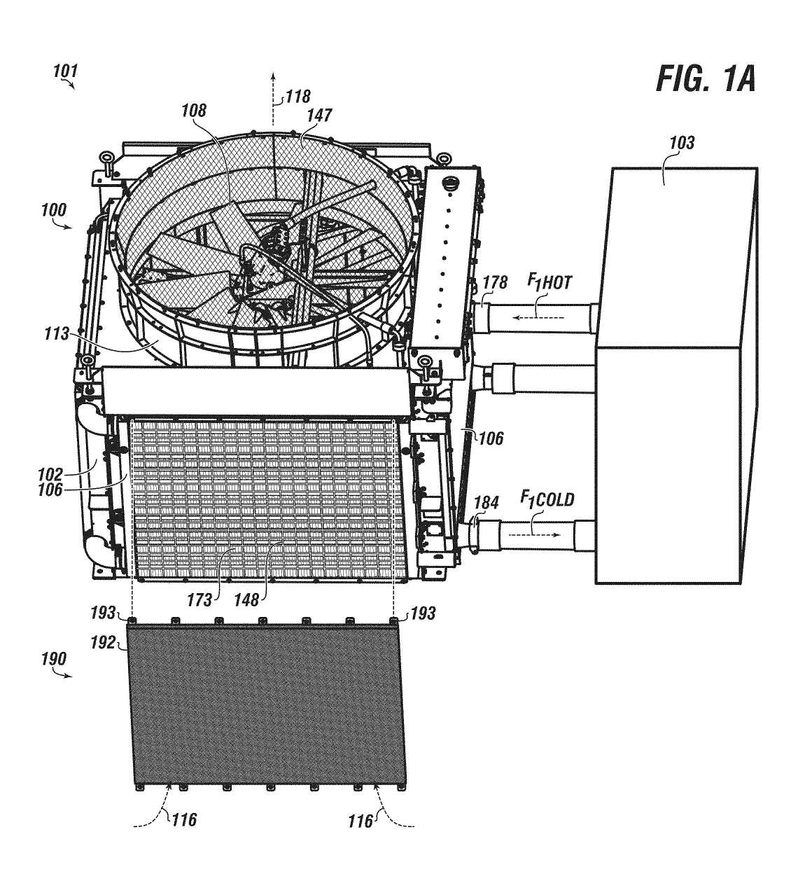

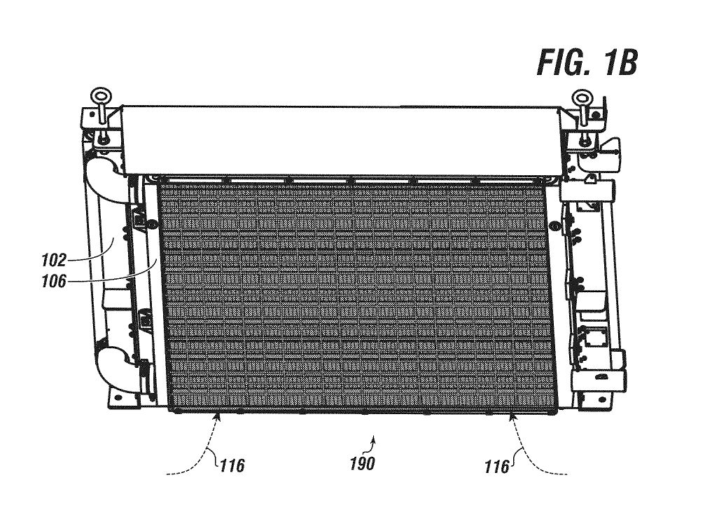

Referring now to FIG. 1, a side view of a heat exchanger unit having an at least one filter assembly, and being further coupled with a heat generation device, in accordance with embodiments herein, is shown.

Embodiments herein pertain to an HX unit 100 that may include a frame 102 with one or more coolers 106 coupled therewith. Although shown here as a vertical or cube-type orientation, with a sucker fan, the HX unit 100 is not meant to be limited, and other orientations, configurations, operations, and so forth are possible.

The HX unit 100 may have an operable fan system or fan 108 associated therewith. Briefly, the fan may include related subcomponents, including which may be understood to include a rotating member with a plurality of fan blades extending therefrom. The fan 108 may be operable by way of a suitable driver, such as a fan motor, which may be hydraulic, electrical, gas-powered, etc. Conduits may be configured for the transfer of pressurized hydraulic fluid to and from the motor. As such, pressurized hydraulic fluid may be used to power the motor.

The fan 108 may have an operating speed range of about 600 rpm to about 2000 rpm. In embodiments, the speed range may be about 900 rpm to about 1000 rpm, which may be particularly suitable to a frac site.

The fan 108 may include or be associated with a fan shroud 113, which may be generally annular. The fan shroud 113 may be coupled to the frame 102, such as via connection with a top plate. A fan rock guard 147 may be coupled proximately to the (top end of the) shroud 113. The (bottom end of the) shroud 113 may be proximate to an aeroring (not shown). The aeroring may be annular in nature, and have a ring cross-section that may have a radius of curvature.

By way of example, utility fluid Fi may be transferred from a heat generating device 103 at a hot temperature into an HX unit inlet 178, cooled with cooling medium via core 106, and transferred out of an HX unit outlet 184 back to the HGD 103 at a cooler temperature. While not meant to be limited, HGD 103 may be an engine, a genset, a motor, a pump, or other comparable equipment that operates in a manner whereby a utility fluid is heated, and in this respect is merely illustrated in block diagram form. System 101 may include the HX unit 100 in operable engagement (including fluid communication) with HGD 103.

There may be one or more cores 106. A ‘cooler’ or ‘cooling circuit’ may include one or more cores 106. The HX unit 100 may have between about 1 to about 8 cooling circuits, which each may be configured for cooling in parallel to each other.

The HX unit 100 may include various features, including improvements in sound reduction or integrity, like that as in pending U.S. patent application Ser. No. 15/477,097, being incorporated by reference herein in its entirety, and being particular to such various HX configurations, sound baffle configurations, and/or flexible mount assemblies shown and described therein.

The HX unit 100 may include various monitoring features like that as in pending U.S. patent application Ser. Nos. 15/591,076 and 15/705,024, each being incorporated by reference herein in its entirety, and being particular to such various monitoring aspects shown and described therein.

Embodiments herein apply to an HX unit that may be an inclusive assembly of a number of components and subcomponents, which may be further associated with operable systems, subsystems, assemblies, modules, and so forth that may overall be referred to as a system, like that as described and shown in the aforementioned Applications. Thus, various discussion of system 101 may be provided in brevity, recognizing that differences, if any, would be discernable by one of skill in the art in accordance with the disclosure, as well as in view of the Applications. It would be further understood that aspects of system 101 may include various additional improvements related to airflow, noise reduction, cooling efficiency, structural integrity, cooler orientation or arrangement, and combinations thereof.

In operation, utility fluid F from HGD 103 may be transferred into the HX unit 100. The transfer may be direct or indirect (such as from a holding tank). Within the unit 100, the fluid may flow into a tank chamber (not shown) via inlet 178 of inlet tank. The fluid then distributes into the various alternating layers and respective channels of the core 106.

Similarly airflow 116 may be drawn into HX unit 100, and into the various perpendicular and alternating layers and respective channels of the core 106. The HX unit 100 may be configured for passing atmospheric air through or in contact with the core 106, so as to reduce the temperature of the service fluid circulated through the core 106. In this respect, a fan (or fan system) may be rotatable about a fan axis so as to draw in (or suction, etc.) atmospheric air inwardly through channels (or fins 173), resulting in airflow through the core 106.

The service fluid F₁₋ₕₒₜ, having a temperature hotter than the airflow, may be cooled (and conversely, the airflow warms). Cooled service fluid F_{1-cold} leaves the cooling circuit via a fluid outlet 184. Various piping, tubing, etc. may be connected to the tank outlet 184, as may be desired for a particular application, and as would be apparent to one of skill in the art. In some aspects, the tank outlet 184 may be in fluid communication with an inlet of a subsequent cooling circuit or core 106 also connected with the frame 102.

The fan system can be operable to draw in and direct the flow of air 116. The air 116 may be drawn through the sides of the HX unit 100 (and respective cores, which may then be used to cool one or more utility fluids F) and out as heated exhaust 118.

Cooled utility fluid may be returned from the HX unit 100 to a source tank, or directly to the HGD 103. Thus, service fluid from the HGD 103 may be circulated in a cooling circuit in a systematic and continuous manner. As will be appreciated, a suitable circulating pump (not shown) may be provided to circulate the service fluid through the core cooler 106. The cooler may include a first set of fins oriented in a first direction, and a second set of fins oriented in a second direction that is perpendicular to the first direction.

Other coolers of the HX unit 100 may be generally similar in nature, and suitably configured for the cooling of various service fluids from the HGD 103. While not meant to be limited, HGD 103 may be an engine, a genset, a motor, a pump, or other comparable equipment that operates in a manner whereby a utility fluid is heated.

Embodiments herein provide for system 101 (and related method of operating or using the system) using or being associated with other aspects described herein. For example, although not shown here system 101 may include a wellbore and other wellbore and production equipment, as well as a frac trailer. The frac trailer may include a frac pump, a HGD, and a HX unit as pertaining to the disclosure.

To aid in prevention or mitigation of fouling of any respective cooler 106 (or fins 173), the HX unit may have a filter assembly 190 coupled therewith. The assembly 190 may have a fastener 193 for coupling the assembly 190 with the HX unit 100. The filter assembly 190 may include a filter medium 192. The medium 192 may be a flexible mesh fabric, such as nylon. The medium 192 may be other materials, such as woven fiber, carbon fiber, fiberglass, spun fiberglass, stainless steel, other pliable fabrics, synthetic or natural polymers, and so forth. The medium 192 may be provided in one or more layers.

As shown here, the filter assembly 190 may be installed entirely over (or around) a protective fin grate 148. The filter assembly 190 may have varied forms of coupling to the HX unit 100. For example, the filter assembly 190 may include a hook and loop fastener, such as Velcro, associated with the HX unit 100.

While not meant to be limited, the filter assembly 190 may generally rectangular in nature in order to properly fit over the grate 148. In embodiments, the filter assembly 190 may range in L-x-W from about 10″×10″ to about 90″×90″, and any suitable dimensional size therebetween. The filter assembly 190 may be configured coupling with any type heat exchanger unit, as may be desired.

Of significance for the filter assembly 190 is mesh size and thread diameter (NOTE: thread diameter may pertain to a ‘thickness’ of a given strand of material). The filter assembly 190 must not contribute significantly to pressure drop, but yet still provide coveted filtration. Moreover, different areas of the core 106 experience different flow rates that is further varied by the fan speed. Therefore, significant attention and design have been paid to finding synergy between filtration ability with impact on HX unit performance.

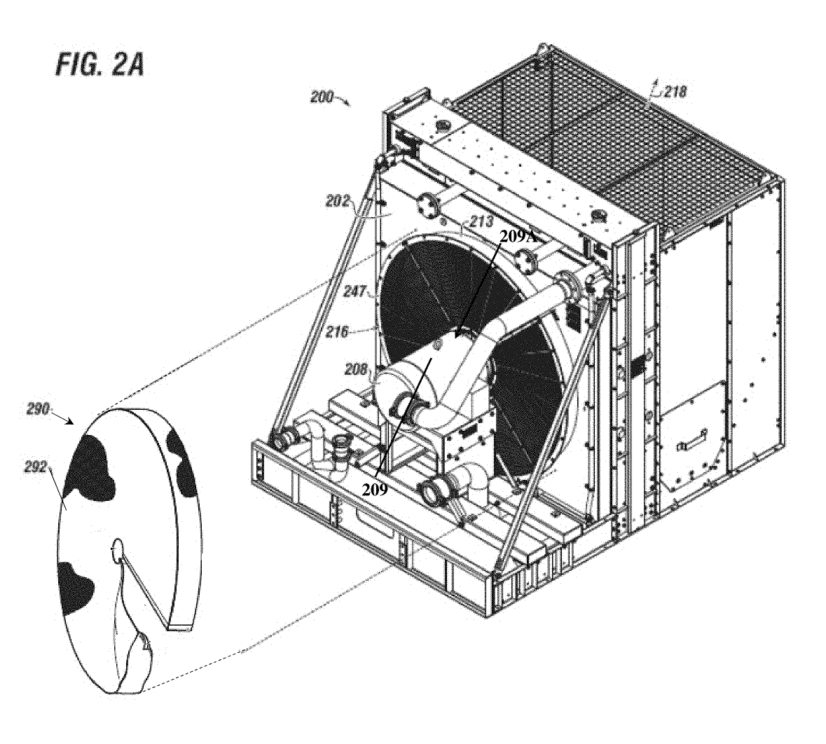

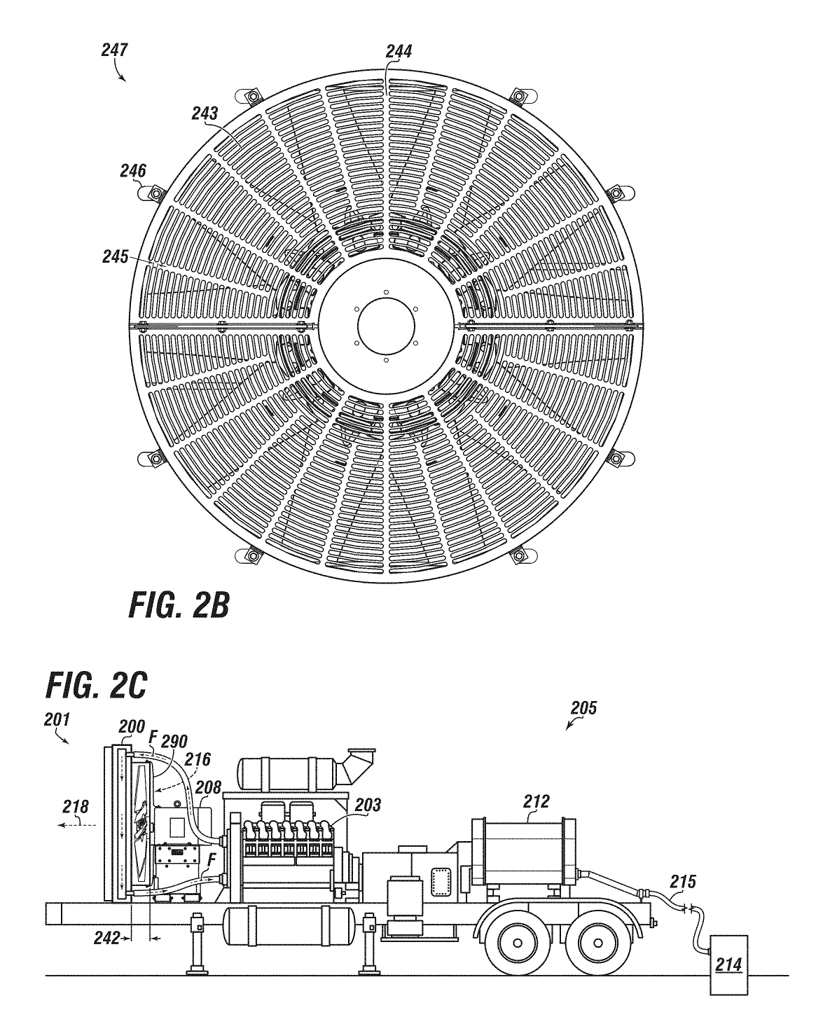

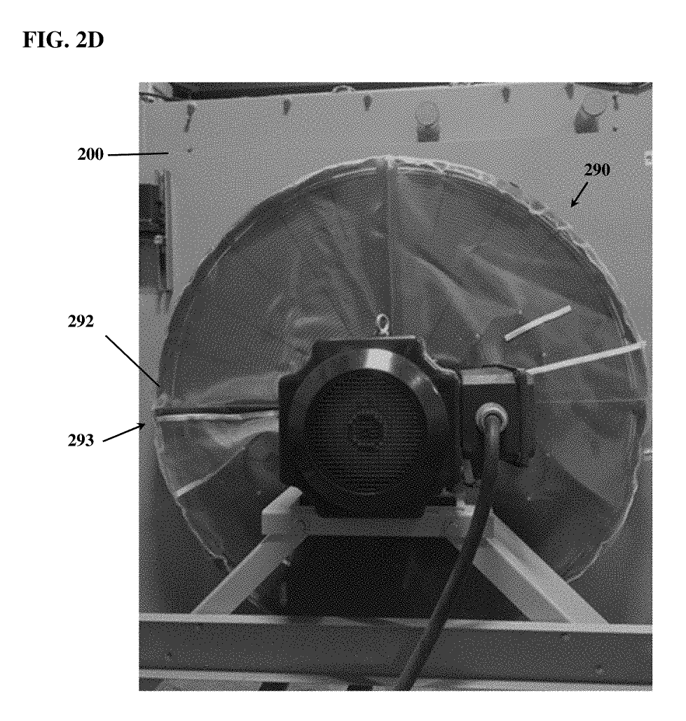

Referring now to FIGS. 2A, 2B, and 2C a side view of a heat exchanger unit having an at least one filter assembly, and further having a blower, and a close-up view of a fan finger guard, and a view of frac pump system, respectively, in accordance with embodiments herein, is shown.

System 201, and any components thereof, may be like that of other systems described herein or in the Applications, such as system 101. Thus, various discussion of system 201 may be provided in brevity, recognizing that differences, if any, would be discernable by one of skill in the art in accordance with the disclosure, as well as in view of any application incorporated by reference. It would be further understood that aspects of system 201 may include various additional improvements related to airflow, noise reduction, cooling efficiency, structural integrity, cooler orientation or arrangement, and combinations thereof.

Embodiments herein pertain to an HX unit 200 may include a frame 202 with one or more coolers coupled therewith. Although shown here as a vertical orientation, with a blower fan, the HX unit 200 is not meant to be limited, and other orientations (e.g., horizontal), configurations, operations, and so forth are possible. System 201 may include the HX unit 200 in operable engagement (including fluid communication) with a heat generating device (HGD).

The HX unit 200 may have an operable fan system or fan 208 associated therewith. Briefly, the fan may include related subcomponents, including which may be understood to include a rotating member with a plurality of fan blades extending therefrom. The fan 208 may be operable by way of a suitable driver, such as a fan motor, which may be hydraulic, electrical, gas-powered, etc. Conduits may be configured for the transfer of pressurized hydraulic fluid to and from the motor. As such, pressurized hydraulic fluid may be used to power the motor.

The fan 208 may have an operating speed range of about 600 rpm to about 2000 rpm. In embodiments, the speed range may be about 900 rpm to about 1000 rpm, which may be particularly suitable to a frac site. One of skill would appreciate fan 208 may be operable as a blower, and thus blowing air through the radiator core (as compared to sucking).

The fan 208 may include or be associated with a fan shroud 213, which may be generally annular. A safety or finger guard 247 may be coupled proximately to the shroud 213 in a manner whereby the risk of a hand, finger, or other body part coming into contact with moving fan blades is mitigated.

As shown in FIG. 2B, the finger guard 247 may include windings 243 supported by ribs 244. The finger guard 247 may be mounted to the HX unit via one or more mount features 246. The finger guard 247 may have a clearance 245 between windings in a range of about ⅛″ to about ½″. A width (thickness, diameter, etc.) of any particular winding 243 may be in a range of about 1/16″ to about ¼″. The finger guard 247 may have a guard depth (or height) of about 1″ to about 7″. To be sure, while the finger guard 247 is illustrated here as circular with windings, the guard 247 may have other shapes, such as rectangular with vertical/horizontal elements crossing each other.

The HX unit 200 may include various sound reduction or integrity features like that as in pending U.S. patent application Ser. No. 15/477,097, being incorporated by reference herein in its entirety, and being particular to such various sound baffle configurations and/or flexible mount assemblies shown and described therein.

The HX unit 200 may include various monitoring features like that as in pending U.S. patent application Ser. Nos. 15/591,076 and 15/705,024, each being incorporated by reference herein in its entirety, and being particular to such various monitoring aspects shown and described therein.

In operation, a utility fluid F may be transferred into the HX unit 200. The transfer may be direct or indirect (such as from a holding tank). Similarly airflow 216 may be drawn into HX unit 200, and thus blown via the fan 208 into the various perpendicular and alternating layers and respective channels of the core. The HX unit 200 may be configured for blowing atmospheric air through or in contact with the core, so as to reduce the temperature of the service fluid circulated through the core. In this respect, a fan (or fan system) may be rotatable about a fan axis so as to draw in (or suction, etc.) atmospheric air inwardly through channels, resulting in airflow through the core, and out as heated exhaust 218.

While not meant to be limited, HGD may be an engine, a genset, a motor, a pump, or other comparable equipment that operates in a manner whereby a utility fluid is heated.

Embodiments herein provide for system 201 (and related method of operating or using the system) using or being associated with other aspects described herein. For example, FIG. 2C shows system 201 may include a wellbore 214 and other wellbore and production equipment (e.g., piping 215), as well as a frac trailer 205. The frac trailer 205 may include a frac pump 212, a HGD 203, and a HX unit 200 as pertaining to the disclosure.

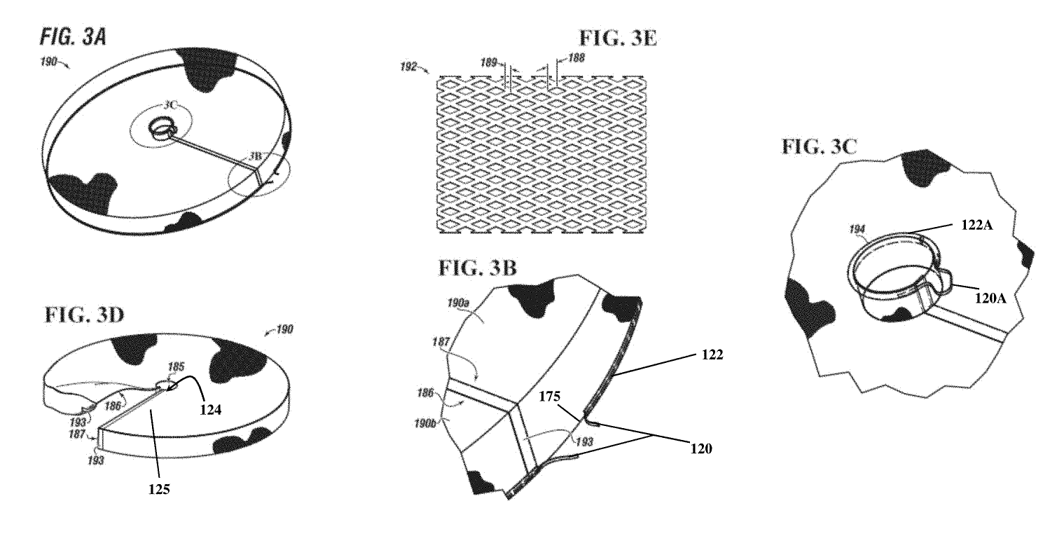

To aid in prevention or mitigation of fouling of any respective cooler, the HX unit 200 may have a filter assembly 290 coupled therewith. Filter assembly 290 may be like that of embodiments described herein. As shown here, the filter assembly 290 may be installed entirely over (or around) a protective grate 247. The filter assembly 290 may have varied forms of coupling to the HX unit 200. For example, the filter assembly 290 may include a hook and loop fastener, such as Velcro. In other aspects, the filter assembly may have one or more drawstrings (e.g., 120, 120A, FIGS. 3B-3C).

While not meant to be limited, the filter assembly 290 may generally circular in nature in order to properly fit over the grate 247. In embodiments, the filter assembly 290 may range in diameter from about 20″ to about 90″, and any suitable dimensional size therebetween.

The operation of system 201 may include multiple frac pump units 205. Each unit 205 may be typically operable with the pump 212 and the HGD (engine) 203 mounted or otherwise disposed thereon, and capable of producing upwards of 15,000 psi to an injection fluid.

The frac pump 212 (or pumping system, skid unit, etc.) may be self-contained on a transportable system, such as the trailer unit 205. The system components may include the heat exchanger unit 200. The frac pump 212 may provide pressurized fluid into well(s) 214 via transfer (injection) line(s) 215.

Over time the filter medium 292 will foul, to which a user may readily remove the assembly 290, clean, and reinstall. As an alternative, the filter assembly 290 may be removed, and a new, clean assembly 290 be installed in its place. The fouled assembly 290 may thus optionally be removed from the field for remote cleaning and/or disposal.

Briefly, FIG. 2D illustrates the filter assembly 290 (coupled around a fan guard, and a fan motor housing) with ends (186, 187) coupled together via coupler 293.

Referring now to FIGS. 3A-3E together, an isometric view of a rounded filter assembly, a zoom-in view of a mesh material, an isometric view of a filter assembly having a first end and a second end, a close-up view of the assembly of FIG. 3A coupled together, a close-up view of an insert mount of the assembly of FIG. 3A, an isometric view of ends of the assembly of FIG. 3A uncoupled, and a close-up view of a filter material, respectively, in accordance with embodiments disclosed herein, are shown.

As shown particularly in FIG. 3E, the filter medium 192 may have a mesh size 188. Although shown here as a single mesh, mesh size may refer to an overall average size opening of a plurality of meshes. The mesh size 188 may be in a range of about 140 microns to about 700 microns. In aspects, the mesh size 188 may be about 575 microns to about 625 microns. In yet other aspects, the mesh size 188 may be about 355 microns to about 600 microns. In yet other aspects, the mesh size 188 may be about 600 microns.

Typically mesh size 188 may be contemplated in terms of diameter, effective diameter, or width, but mesh size 188 need not be an exact perfect circle or square. In this respect, any particular opening of the filter medium 192 may be, but need not be, of an exact geometrical symmetry. Thus, there may be variation of any particular mesh opening 188, and/or there may be variation between mesh openings 188 of medium 192.

Thread size 189 (e.g., diameter, width, lateral distance, thickness, etc.) in connection with mesh size 188 may attribute to overall percentage of opening. The thread size 189 may be in the range of about 50 microns to about 180 microns.

FIGS. 3A and 3D illustrate the filter assembly 190 may be a unitary piece with various subcomponents, and/or may be comprise one or more pieces coupled together. For example, the assembly 190 may have a top portion 190a coupled with a side portion 190b. As shown here, the top portion 190a may be generally circular, and the side portion 190b may be generally ring shape or annular. An edge 175 of the side portion 190b may have a hem 122 (or other form of configuration) therearound for holding a drawstring 120. In this respect, the drawstring 120 may be pulled or tightened, resulting in the edge 175 tightening around the fan guard (247, FIG. 2A).

The filter assembly 190 may include the medium 192 coupled with a fastener 193. The fastener 193 may be configured for coupling portions of the assembly 190 together. For example, the filter assembly 190 may have a first assembly end 186 coupled with a second assembly end 187.

The fastener 193 may be a hook and loop type fastener, such as Velcro. Thus, a first part of the fastener (e.g., the hook) may be on the respective first assembly end 186, and a second part of the fastener (e.g., the loop) may be on the respective second assembly end 187. Other types of fasteners include, but are not limited to, zippers, snaps, buttons, straps, elastic banding, adhesive, magnets, quick-disconnects, and so forth. The fastener 193 may be coupled with the assembly in any suitable manner, such as glue, sewing, double sided tape, other comparable forms of adhesive, and so forth.

The assembly 190 may include an opening (or cut, gap, etc.) 185. In this respect, the assembly 190 may be easily fit and installed around a fan. The assembly 190 may include a mount insert 194 coupled therewith, which may fit and install around an end (FIG. 2A, 209A) of a fan motor housing (209), the end being most proximate to the fan guard. The mount insert 194 may be configured to seal or otherwise restrict the amount of room or passageway between the mesh material 192 and the fan. The smaller this area is, the more the cooling fluid is forced through the filter assembly 190. Put another way, a fluid will take the least path of resistance—the region between the assembly 190 and the fan motor housing—so minimization is desired. In embodiments, there may be a gap between the fan motor housing and the mount insert 194 in a range of about 1/16″ to about ½″.

The mount insert 194 may be configured for fitting around the fan motor housing, and thus being installed therearound. The assembly 190 may similarly have an inner drawstring 120A for tightening around the fan motor housing (209).

The filter assembly 190 may be formed from a pre-cut, pre-shaped width of porous, nonwoven material, such as nylon. The material may be folded upon itself in a known manner to form a seam

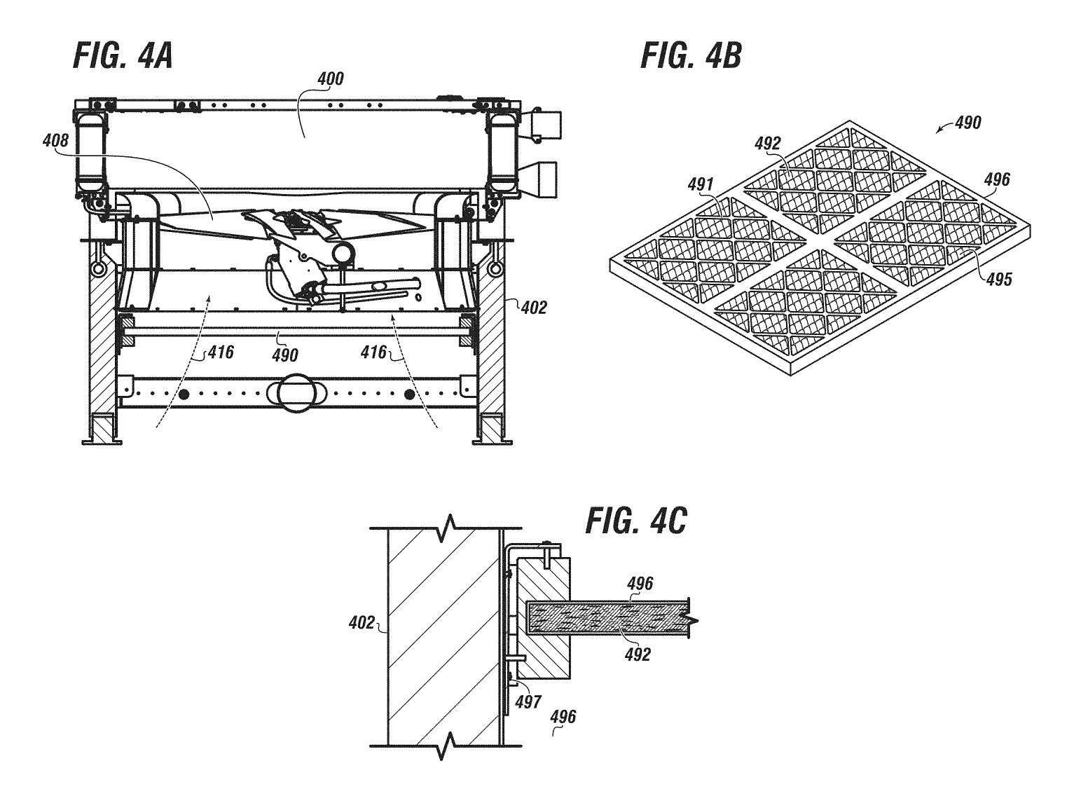

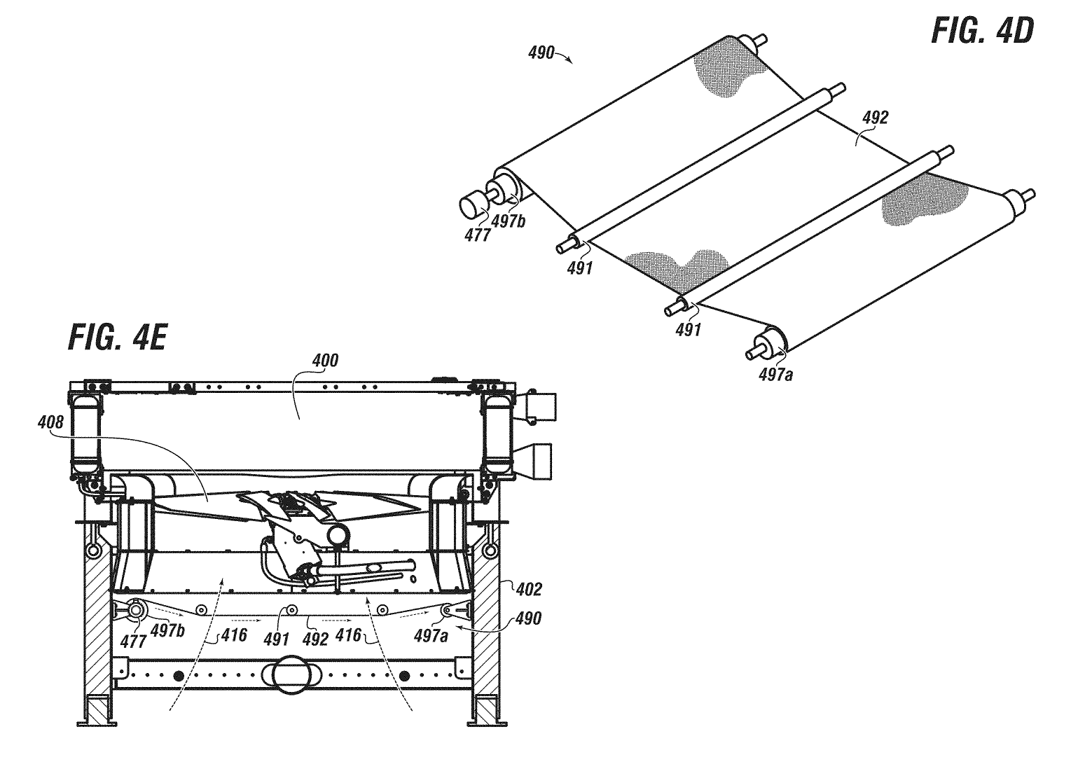

Referring now to FIGS. 4A, 4B, 4C, 4D, and 4E together, a side view of a filtration device coupled with a heat exchanger unit, an isometric view of a filtration device suitable for use with a heat exchanger unit, a partial side view of a filtration device and a mount suitable for use with a heat exchanger unit, an isometric view of a rollable filtration device suitable for use with a heat exchanger unit, and a side view of a rollable filtration device suitable for use with a heat exchanger unit, respectively, in accordance with embodiments disclosed herein, are shown.

The filter assembly 490 may be used with HX units of embodiments herein and variants thereof. The filter assembly 490 may be used with other HX units, including new and or as otherwise manufactured, or may be readily retrofitted to existing units.

FIG. 4A illustrates where the filter assembly 490 may be located, which may be on the air intake side of HX unit 400. One of skill would appreciate that although illustrated as the bottom, air intake side of a horizontal configuration, and before the fan/fan blade, other configurations are possible. Accordingly, filter assembly 490 may be disposed, associated with, operably positioned, etc. between a frame 400 and a fan 408 (or fan system), over a fan guard, etc. Air 416 may be pulled (sucked) through filter material or medium 492 of the filter assembly 490 before moving through the HX unit 400.

FIGS. 4B and 4C illustrate the filter assembly 490 may include a filtration medium 492, such as woven fiber, which may be metallic or non-metallic (e.g., polyester), or other pliable materials, such as nylon. The filter assembly 490 may include a frame 496. Although shown as square or polygonal, other shapes of the frame 496 are possible. The frame 496 may be fixedly coupled (mounted, etc.) to the frame 402 of the HX unit 400, such as with bolts or other suitable fasteners 498.

The filter assembly 490 may have one or more sections or panels, for which the medium 492 may be disposed therein. FIG. 4B illustrates a four-section (or also quadrant) filter assembly 490 with four panels 495.

The filter panels 495 may be configured for engaging (such as slidingly engaging) into the frame 496. The panel 495 may be configured with a channel or other suitable structure to hold the filter medium 492. The filter assembly 490 (or panel 495) may include a retention device, such as a wire grid, 491, which may be configured to retain the medium 492 therein, and thus preventing it from being pulled into the fan. Once any component of the filter assembly 490 becomes dirty, the filter assembly 490 (or panel(s) 495) may be removed, cleaned, such as via power wash, and reinstalled.

FIGS. 4D and 4E illustrate a rollable or moving ‘cleanable filter system’. In this embodiment, the filter assembly 490 may include a pliable filtration medium 492, such as nylon fabric. The medium 492 may include one or more small holes or mesh openings in it. The medium 492 may be wound onto a first roller or roll 497. As the medium 497 fouls, an operator may turn (or cause to turn) a small motor 477 (any suitable type motor would suffice) on. In operation, the motor 477 may rotate second roller or roll 497b, thereby pulling the fouled medium 492 sufficient enough distance whereby clean medium 492 may then be exposed to the air intake. Thus, the motor and rollers operate to wind and pull the material 492. The filter assembly 490 may include the retention mechanism 491, which may be fixed rollers or bars, which may be useful to keep or otherwise prevent the medium 492 from being pulled up into the fan 408. In this concept, once all of the material 492 has been used, the roll may be removed, the material 492 cleaned, and then rerolled onto one of the rollers 497a,b and reused.

These embodiments and their variants provide a simple pre-filter screen for the HX unit 400 to keep it from plugging or otherwise fouling from debris and particles of dirt, dust, sand, and so forth.

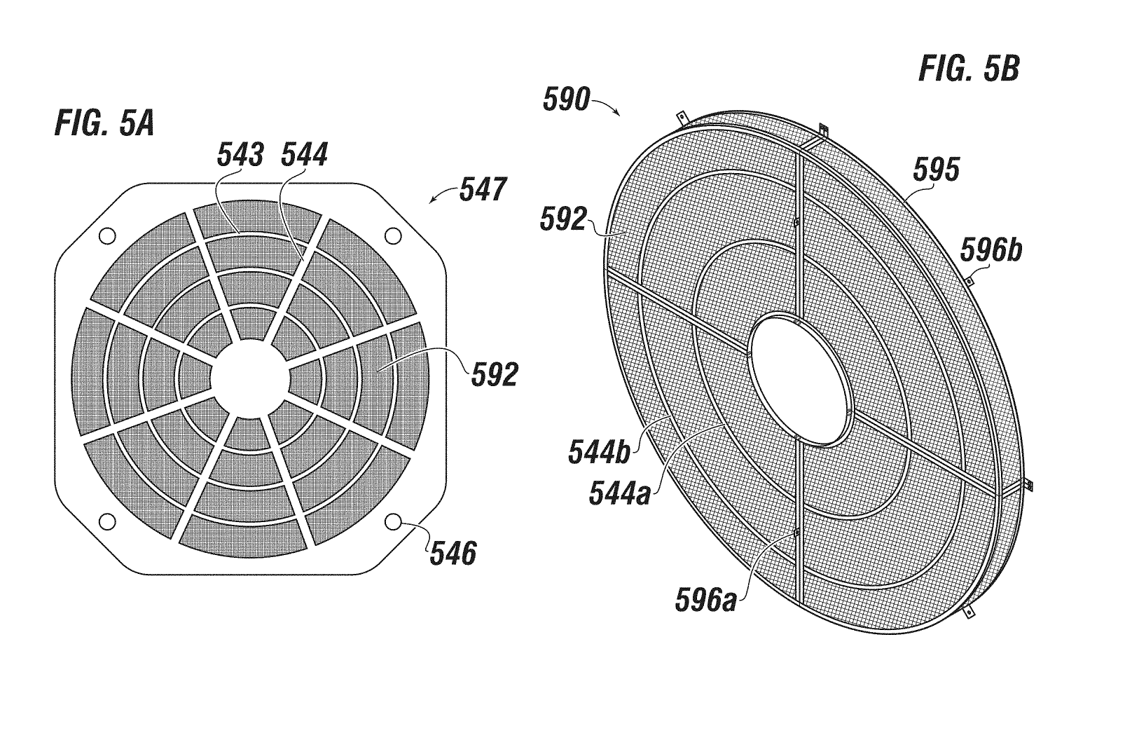

Referring briefly to FIGS. 5A and 5B, a front view of a modified finger guard and an isometric view of a rigid filter assembly, respectively, according to embodiments herein, are shown.

FIG. 5A illustrates an embodiment where a ‘filter assembly’ of the present disclosure may be a finger guard 547 combined with a filter medium 592. Thus, this version of the filter assembly 547 may include windings 543 supported by ribs 544. The filter assembly 247 may be mounted to the HX unit via one or more mount features 545.

FIG. 5B illustrates an embodiment of a rigid filter assembly 590 comparable to that of FIG. 5A, except this assembly 590 would be assembleable over a finger guard (e.g., 247). Here the assembly 590 entails a plurality of cartridges 595, each having a filter medium 592. The filter medium 592 is maintained between or coupled with a frame-type structure having one or more ribs 244a,b.

The cartridges may be coupled together via one or more couplers 596a. The couplers 596a may be any suitable coupler, such as eyelets with respective nuts and bolts, magnets, and so forth. The assembly 590 may be coupled around a fan and onto an HX unit via couplers 596b. The cartridges 595 may assemble together in a manner that leaves an opening 585.

### Advantages

Embodiments of the disclosure advantageously provide for an improved heat exchanger unit useable with a wide array of heat generating devices.

By installing a removable filter assembly, the assembly may be readily removed from a heat exchanger unit with no to minimal tools. While the used filter can be taken back to a proper location for cleaning and use on future equipment, a new filter can be installed thereon. This eliminates the need for costly downtime, movement of the equipment or temporary cleaning locations at large job sites. By keeping the radiator clean and free of fouling it also helps to keep the machine running in better performance.

The design solution of the filter assembly provides a simple design that is easy to install and remove. The assembly can be installed on existing equipment in the field or on new production equipment quickly and easily.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure presented herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of any claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A filter assembly comprising:
a pliable body made of a filter medium, and further comprising:
a first end extending from an inner region through a middle portion to an outer perimeter end;
a second end extending from the inner region through the middle portion to the outer perimeter end, the second end configured for coupling with the first end;
an outer perimeter comprising the outer perimeter end;
a drawstring disposed circumferentially around the outer perimeter end; and
a central opening;
a mount insert coupled with the pliable body in the central opening, the mount insert further comprising a closeable opening, whereupon the mount insert is positionable around a fan motor housing and the closeable opening being closeable therearound,
wherein the filter medium comprises nylon, wherein the filter medium comprises a percent opening defined by an average mesh size opening, and an average thread size, wherein the average mesh size opening is in the range of 300 microns to 625 microns, and the average thread size is in the range of 50 microns to 180 microns.

2. The filter assembly of claim 1, wherein the average mesh size opening is in the range of 590 microns to 610 microns.

3. The filter assembly of claim 2, wherein the drawstring is configured for tightening the outer perimeter end around a fan guard associated with a fan blowing air into a heat exchanger unit, wherein the fan operates at a fan speed in the range of 900 rpm to 1000 rpm.

4. The filter assembly of claim 3, wherein an inner drawstring is disposed circumferentially around an inner region perimeter end, the inner drawstring configured for tightening the mount insert around the fan motor housing.

5. The filter assembly of claim 4, wherein the first end and the second end are configured to provide a hook and loop coupling along the entirety of each, and wherein the mount insert is cylindrically shaped with openings on either end thereof.

6. A heat exchanger system comprising:
a heat exchanger unit comprising:
a frame;
an at least one cooler coupled with the frame;
an at least one fan system coupled with the frame proximate to the at least one cooler, the at least one fan system further comprising: a motor operationally coupled with a rotating member, and a fan motor housing disposed at least partially around the motor;
a fan guard coupled to the frame and around the rotating member; and
a filter assembly, the filter assembly comprising:
a pliable body made of a filter medium, and further comprising:
a first end extending from an inner region through a middle portion to an outer perimeter end;
a second end extending from the inner region through the middle portion to the outer perimeter end, the second end configured for coupling with the first end;
an outer perimeter comprising the outer perimeter end;
a drawstring disposed circumferentially around the outer perimeter end; and
a central opening;
a mount insert coupled with the pliable body in the central opening, the mount insert further comprising a closeable opening, whereupon the mount insert is positionable around the fan motor housing and the closeable opening being closeable therearound,
wherein the filter medium comprises nylon, wherein the filter medium comprises a percent opening defined by an average mesh size opening, and an average thread size, wherein the average mesh size opening is in the range of 300 microns to 625 microns, and the average thread size is in the range of 50 microns to 180 microns, and wherein the rotating member operates to blow air through the at least one cooler.

7. The heat exchanger system of claim 6, wherein the average mesh size opening is in the range of 590 microns to 610 microns, and wherein the drawstring is configured for tightening the outer perimeter end around a fan guard associated with the fan.

8. The heat exchanger system of claim 7, wherein an inner drawstring is disposed circumferentially around an inner region perimeter end, the inner drawstring configured for tightening the mount insert around the fan motor housing, and wherein the fan operates at a fan speed in the range of 900 rpm to 1000 rpm.

9. The heat exchanger system of claim 8, wherein the first end and the second end are configured to provide a hook and loop coupling along the entirety of each, wherein the mount insert is cylindrically shaped with openings on either end thereof, and wherein the heat exchanger unit is operably coupled with a heat generating device.

10. The heat exchanger system of claim 9, wherein the heat generating device is a diesel engine operably associated with a frac pump, and wherein the heat exchanger unit, the heat generating device, and the frac pump are disposed on a frac trailer.

11. A heat exchanger system comprising:
a heat generating device;
a heat exchanger unit operably coupled with the heat generating device, the heat exchanger unit further comprising:
a frame;
an at least one cooler coupled with the frame;
an at least one fan system coupled with the frame proximate to the at least one cooler, the at least one fan system further comprising: a motor operationally coupled with a rotating member, and a fan motor housing disposed at least partially around the motor;
a fan guard coupled to the frame and around the rotating member; and
a filter assembly, the filter assembly comprising:
a pliable body made of a filter medium, and further comprising:
a first end extending from an inner region through a middle portion to an outer perimeter end;
a second end extending from the inner region through the middle portion to the outer perimeter end, the second end configured for coupling with the first end;
an outer perimeter comprising the outer perimeter end;
a drawstring disposed circumferentially around the outer perimeter end; and
a central opening;
a mount insert coupled with the pliable body in the central opening, the mount insert further comprising a closeable opening, whereupon the mount insert is positionable around the fan motor housing and the closeable opening being closeable therearound,
wherein the filter medium comprises nylon, wherein the filter medium comprises a percent opening defined by an average mesh size opening, and an average thread size, wherein the average mesh size opening is in the range of 300 microns to 625 microns, and the average thread size is in the range of 50 microns to 180 microns, and wherein the rotating member operates to blow air through the at least one cooler, and wherein the drawstring is configured for tightening the outer perimeter end around a fan guard associated with a fan blowing air into a heat exchanger unit.

12. The heat exchanger system of claim 11, wherein an inner drawstring is disposed circumferentially around an inner region perimeter end, the inner drawstring configured for tightening the mount insert around the fan motor housing.

13. The heat exchanger system of claim 12, wherein the first end and the second end are configured to provide a hook and loop coupling along the entirety of each, and wherein the mount insert is cylindrically shaped with openings on either end thereof.

14. The heat exchanger system of claim 13, wherein the heat generating device is a diesel engine operably associated with a frac pump, and wherein the heat exchanger unit, the heat generating device, and the frac pump are disposed on a frac trailer.

15. The heat exchanger system of claim 14, wherein the frac pump operates to inject fluid into a wellbore, and wherein a service fluid is transferred from the heat generating device to the heat exchanger unit for cooling.

16. The heat exchanger system of claim 15, wherein the service fluid comprises one of lube oil, hydraulic fluid, fuel, and transmission fluid, and wherein the fan operates with a fan speed in a range of 600 rpm to 2000 rpm.

17. The heat exchanger system of claim 16, wherein the fan guard has a clearance between respective windings in a range of ⅛″ to about ½″, and the fan guard has a depth in a range of 1″ to 7″, wherein the filter assembly is generally circular having a diameter of 70″ to 90″.
